(19) United States
(12) Patent Application Publication
(10) Pub. No.: US 2003/0108062 A1
(43) Pub. Date: Jun. 12, 2003

(54) Unitary, multiple-interface terminal operating with different transmission protocols over a common frequency range

(76) Inventors: Prathima Agrawal, New Providence, NJ (US); David Famolari, Montclair, NJ (US)

Correspondence Address: Joseph Giordano, Esq., Telcordia Technologies, Inc., Room 1G-112R, 445 South Street, Morristown, NJ, 07960, US

(21) Appl. No.: 10/016,100

(22) Filed: Dec. 10, 2001

(51) Int. Cl. H04L 12/66

(52) U.S. Cl. 370/463; 370/465

(57) ABSTRACT

A multiple-interface radio terminal is provided with facilities which dynamically assign a stream of packet data to be transmitted to a selected one of a plurality of interface(s). The interfaces respectively support channels that share a common frequency spectrum but that operate with different transmission protocols, for example the Bluetooth and 802.11 protocols. The terminal is provided with an interface manager that periodically transmits query signals to the respective channels to obtain and store refreshable inputs representative of a selected transmission condition(s) on such channels. Upon the occurrence of a connection request at the terminal, the interface manager compares the latest stored samples from the respective channels with a reference metric to generate an indication which represents the relative states of the channels with regard to the selected transmission condition. The terminal further includes a selector which utilizes an indication from the interface manager to route the incoming packets to be transmitted to the particular interface whose associated channel exhibits the desired relative state.

### BACKGROUND OF THE INVENTION

This invention relates to packet transmission systems whose channels operate with diverse transmission protocols, and more particularly to such systems and related terminals whose channels share a common frequency spectrum.

Packet data transmission on parallel channels operating over a common frequency range but utilizing different radio protocols is now common. For example, when such transmission is in the 2.4 GHz Industrial—Scientific—Medical band, a first subset of the channels may utilize the Bluetooth protocol, while another subset of the channels may utilize the IEEE802.11 protocol. Streams of data to be transmitted in this manner are often assigned to specified ones of such parallel channels by associated radio terminals. In the presence of a deterioration of transmission conditions on one of the channels, the data assigned to such channel is subject to distortion, delay and the like. Certain techniques are available that attempt to minimize such adverse effects on data that is currently propagating on the affected channel. However, such techniques have not been fully satisfactory, particularly where real-time or other high-priority information is being transmitted.

### SUMMARY OF THE INVENTION

The present invention provides a multiple -interface radio terminal that, a priori, assigns a stream of packet data to be transmitted to a selected one of a plurality of interface(s) that support disparate channels that share a common frequency spectrum but that operate with different transmission protocols. The selection is made dynamically by the terminal through an interface manager in response to periodically obtained refreshable inputs representative of selected transmission conditions on the respective channels.

In an illustrative embodiment wherein the terminal utilizes disparate first and second interfaces of the type indicated in the previous paragraph, the terminal includes a selector operable between first and second modes for respectively directing incoming packets to the first and second interfaces. The interface manager periodically receives samples of quantities representing the selected transmission criteria on the respective channels, and stores them over separately selectable times. Upon the occurrence of a connection request at the terminal, the interface manager compares the latest stored samples from the respective channels with a reference metric to generate first and second indications. The interface manager operates the selector in the first mode when the first and second indications differ in one sense and in the second mode when such indications differ in the opposite sense.

### BRIEF DESCRIPTION OF THE DRAWING

These and other features of the invention are further set forth in the following detailed description taken in conjunction with the appended drawing, in which:

FIG. 1 is a block diagram of an illustrative multiple-interface radio terminal for separately supporting packet transmission using the Bluetooth and 802.11 protocols;

FIG. 2 is a representation of a pair of separate Bluetooth and 802.11 channels over which the terminal of FIG. 1 may communicate with selective ones of a plurality of Bluetooth access points and 802.11 access points; and

FIG. 3 is a block diagram of an interface manager implemented in accordance with the invention and used in connection with the terminal of FIG. 1.

### DETAILED DESCRIPTION

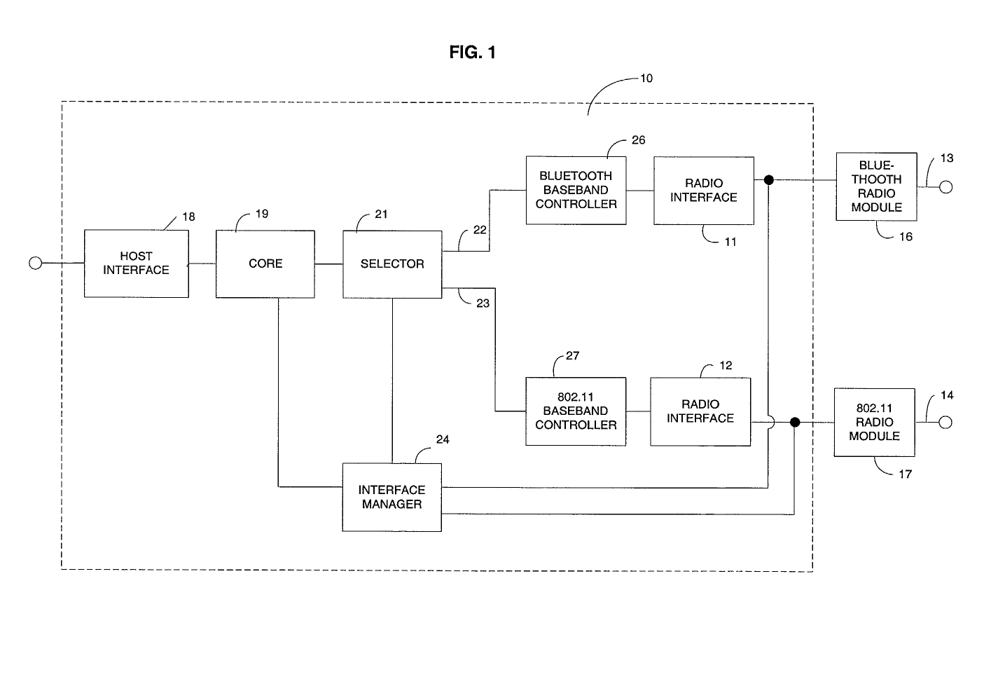

Referring to the drawing, FIG. 1 depicts a terminal 10 illustratively having a plurality of co-located radio interfaces, two of which are shown and represented at 11 and 12. The interfaces 11 and 12 respectively support wireless transmission of application data packets on separate channels or links 13 and 14 that operate within the same frequency band but utilize different standard transmission protocols. Illustratively, the interface 11 supports Bluetooth transmission on the channel 13 via a radio module 16, and the interface 12 supports 802.11 transmission on the channel 14 via a radio module 17.

Connection requests, illustratively in TCP/IP format, are conventionally applied to a host interface 18 of the terminal 10 under the control of an upper layer application, followed by data packets to be transmitted from the terminal 10 after such connection is established. (The structure and operation of the terminal 10, both as already described and as will be further described below, are completely transparent to such upper layer application).

The data packets applied to the host interface 18 for transmission from the terminal 10 are coupled through a CPU core 19 to a selector 21 that is implemented in accordance with one aspect of the invention. The selector 21 has a pair of operating modes wherein the incoming packets associated with each connection request are routed to a separate one of two outputs 22 and 23. The outputs 22 and 23 are respectively associated with the Bluetooth interface 11 and the 802.11 interface 12. In particular, operation of the selector 21 in a first one of such modes will cause packets incident on the terminal 10 to be routed to the Blue tooth output 22, while operation of such selector in the other (second) mode will cause such packets to be routed to the 802.11 output 23. Determination of the operating mode of the selector 21 for any given connection request is governed by an interface manager 24 as indicated below.

The output 22 of the selector 21 is connected to a baseband controller 26 which conventionally encodes packets appearing at the output 22 with conventional FH-CDMA frequency hopping patterns unique to each Bluetooth channel established by the terminal 10. The output 23 of the selector 21 is correspondingly connected to a baseband controller 27 which conventionally encodes packets appearing at the output 23 with conventional 802.11 direct spread frequency patterns unique to each 802.11 channel established by the terminal 10. (As indicated above, only a single pair of channels that respectively carry Blue tooth and 802.11 traffic are depicted in FIG. 1).

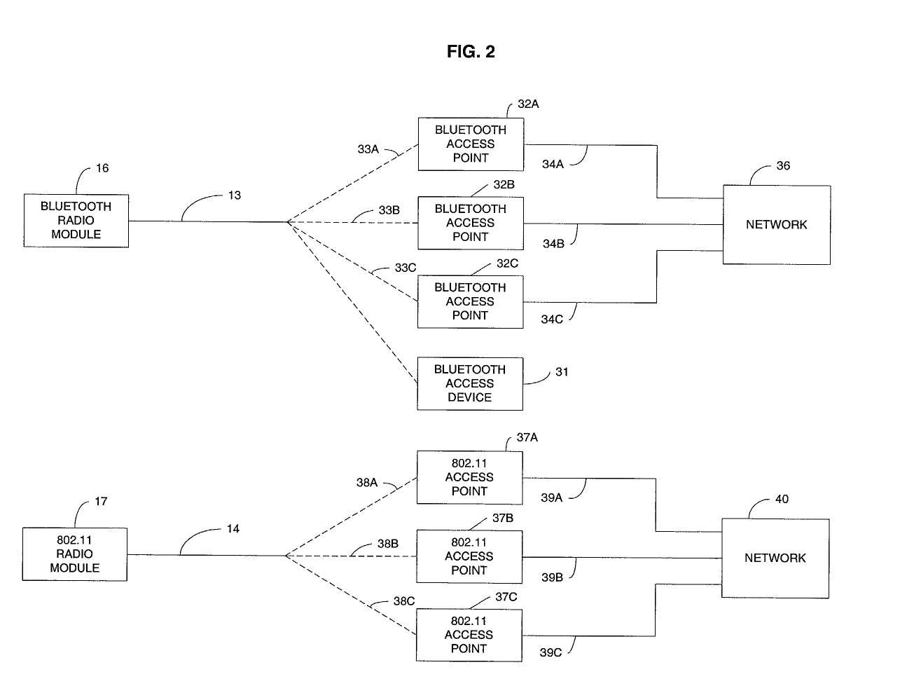

While not specifically indicated in the drawing, it will be understood that the generation of frequency hopping patterns emanating from the controller 26 under Bluetooth protocols may utilize suitable information concerning, e. g., the time of establishment of the Blue tooth connection 13 and the unique, factory set Blue tooth address of the master radio module (illustratively the module 16) that establishes the channel 13. Such inputs are conventionally provided by the module 13 to the controller 26. Corresponding information for the generation of the direct spread frequency patterns by the controller 27 in accordance with 802.11 protocols may be suitably provided to the controller 14 for the channel 14 by the associated radio module 17. Referring to FIG. 2, each of the radio modules 16 and 17 may conventionally establish a connection, over the associated one of the channels 13 and 14, with a correspondent device operating in accordance with the applicable transmission protocol. The correspondent device for the Blue tooth radio module 16 may be a conventional Bluetooth device 31, with which the module 16 may establish a direct peer-to-peer connection. Alternatively, the correspondent device for the radio module 16 may be a selected one of a plurality of conventional Bluetooth access points (3AD's), three of which are illustrated at 32A, 32B and 32C. Such BAD's respectively have radio interfaces 33A, 33B and 33C which are connectable to the channel 13. The BAD's 32A-32C are also respectively provided with second interfaces 34A, 34B and 34C which serve to connect such access points with an external network or terminal represented at 36, either directly or through an intervening wireless network (not shown) as appropriate.

On the 802.11 side, the correspondent device for the radio module 17 on the channel 14 may be a selected one of a plurality of 802.11 access points (AP's), three of which are illustrated at 37A, 37B and 37C. Such AP's respectively have radio interfaces 38A, 38B and 38C which are connectable to the channel 14. The AP's 37A-37C are also respectively provided with second interfaces 39A, 39B and 39C which are connectable to an external network 40.

In accordance with another aspect of the invention, the interface manager 24 determines the operating mode of the selector 21 in accordance with a selected relative transmission condition(s) on the channels 13 and 14. For example, if a connection request is received by the terminal 10 when one of the channels (illustratively the 802.11 channel 14) is already operating at full capacity, the interface manager 24 operates the selector 21 in the first mode, which routes the incoming packets to the output 22. As a result, transmission of such packets will take place over the Bluetooth channel 13.

By contrast, during times when capacity is available on both of the channels 13 and 14, the mode selection by the interface manager 24 may illustratively be governed by a comparison of selected transmission conditions that are sampled at periodic intervals on the respective channels 13 and 14. Among the typical transmission conditions which the interface manager 24 may utilize for this purpose with respect to the Bluetooth channel 13 may be the usage levels of the several access points 32A-32C (as measured in terms of a percentage of available resources), the received signal strength on the channel 13, and transmission delays on such channel. In like manner, typical conditions that may be utilized by the interface manager 24 in connection with 802.11 transmissions over the channel 14 may include the usage level of the several access points 37A-37C, an indication of received signal strength on the channel 14, and transmission delays on such channel. As explained below, the interface manager 24 periodically evaluates indications representative of the selected condition on each of the channels 13 and 14 against a predetermined metric and determines the most advantageous mode for the selector 21 based on such evaluation.

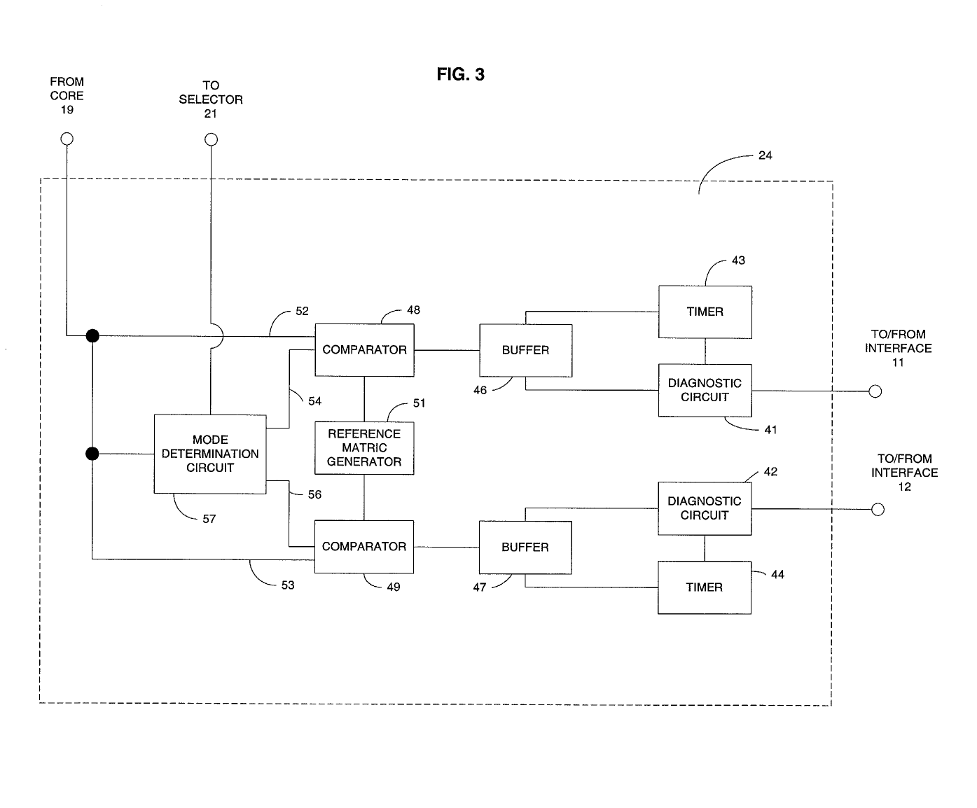

An illustrative embodiment of the interface manager 24 is described in more detail in connection with FIGS. 1 and 3. A pair of diagnostic circuits 41 and 42 are independently coupled to the channels 13 and 14 through the interfaces 11 and 12 and the radio modules 16 and 17. At recurrent first intervals dictated by a pair of associated timers 43 and 44, each of the diagnostic circuits 41 and 42 transmits a beacon signal to the associated channel to collect samples indicative of the selected transmission condition to be evaluated. In response to such beacon signals, samples indicative of the applicable condition on the respective channels are returned to the diagnostic circuit 41 and 42 and are stored in associated buffers 46 and 47 for second recurrent intervals set by the respective timers 43 and 44. The periodic collection of samples continues during the time that the terminal 10 is active, even when there is no connection request incident on the terminal 10.

Preferably, the collection intervals and storage times for the samples requested by the diagnostic circuits 41 and 42 are independently selectable. For example, the diagnostic circuit 41 may collect samples of the relative criteria on the channel 13 every ten seconds, and store them in the associated buffer 46 for five minutes. On the other hand, the diagnostic circuit 42 may collect samples from the channel 14 every twenty seconds, and store them in the associated buffer 47 for sixty minutes. If no connection request occurs during a particular storage interval for one of the samples, such sample is discarded by the associated buffer at the end of the storage interval and refreshed as a later-collected sample.

The outputs of the respective buffers 46 and 47 are applied to first inputs of a pair of comparators 48 and 49. A reference metric for the condition(s) being measured on the channels 13 and 14 is created by a suitable generator 51 and is applied in parallel to second inputs of the comparators 48 and 49. The outputs of the comparators 48 and 49 may therefore represent deviations, from the reference metric established by the generator 51, of the latest refreshed samples of the measured criteria on the channels.

The characteristics of a connection request incident of the terminal 10 may also be employed to fine-tune the information applied to the comparators 48 and 49. For this purpose such connection requests may also be individually applied, via core 19, to inputs 52 and 53 of the comparators 48 and 49. Typical information from the connection requests for this purpose may include, e. g., information regarding bandwidth requirements for the packets to be transmitted and, where the connection request is for a file transfer, the total number of bytes to be transferred.

The outputs of the comparators 48 and 49 are respectively applied to differential inputs 54 and 56 of a mode determination circuit 57. In addition, signals indicative of the occurrence of connection requests applied to the terminal 10 are coupled to a gating input 58 of the determination circuit 57 from the core 19. With this arrangement, each time a connection request is applied to the terminal 10, the then-refreshed output of the determination circuit 57 is gated to the selector 21.

The determination circuit 57 is so configured that when the output of the comparator 48 is greater than the output of the comparator 49, the determination circuit will operate the selector 21 in the first mode. Conversely, when the output of the comparator 49 is greater than the output of the comparator 48, the determination circuit will operate the selector 21 in its second mode. As one example, such opposite relative states on the outputs of the comparators 48 and 49 may illustratively indicate greater or lesser usage levels, respectively, of the 802.11 access points 38A-38C (FIG. 2) relative to those of the Bluetooth access points 32A-32C.

In the foregoing, the invention has been described in connection with illustrative implementations thereof. Many variations, modifications, and other examples will now occur to those skilled in the art. For instance, while the terminal 10 has been exemplified in connection with two channels each operating with a different transmission protocol, it will be appreciated that the principles of the invention are applicable to any reasonable number of channels of each type. It is accordingly desired that the scope of the appended claims not be limited to or by the specific disclosure herein contained.

What is claimed is:

1. A radio terminal for supporting packet transmission, which comprises:
a core;
at least one first interface associated with the core for supporting radio transmission within a first frequency range over an associated first channel in accordance with a first transmission protocol;
at least one second interface associated with the core for independently supporting radio transmission within the first frequency range over an associated second channel in accordance with a second transmission protocol;
means associated with the core for receiving connection requests for packets to be transmitted;
a selector coupled to the receiving means and operable between first and second modes for respectively routing the packets to a separate one of the first and second interfaces; and
an interface manager responsive to each connection request for determining the operating mode of the selector in accordance with a selected transmission condition(s) on the first and second channels.

2. A terminal as defined in claim 1, in which the first transmission protocol is the Bluetooth protocol.

3. A terminal as defined in claim 2, in which the second transmission protocol is the 802.11 protocol.

4. A terminal as defined in claim 1, in which the selected transmission condition includes an indication of received signal strength on the respective first and second channels.

5. A terminal as defined in claim 1, in which the selected transmission condition includes an indication of transmission delays on the respective first and second channels.

6. A terminal as defined in claim 1, in which a selected one of a plurality of Bluebook access points and 802.11 access points are respectively contestable to the first and second interfaces through the first and second channels, and in which the selected transmission condition includes an indication of the usage levels of the access points respectively connectable to the first and second channels.

7. A terminal as defined in claim 1, in which the interface manager comprises, in combination, first means for collecting at first intervals, through the first interface, first samples representative of the selected transmission condition on the first channel, and second means for collecting at second intervals, through the second interface, second samples representative of the selected transmission condition on the second channel.

8. A terminal as defined in claim 7, in which the interface manager further comprises first and second means individually coupled to the first and second collecting means for locally storing, over separately selectable times, the respective first and second samples.

9. A terminal as defined in claim 8, in which the interface manager further comprises, in combination, first means for comparing a stored first sample with a reference metric to obtain a first indicator, second means for comparing a stored second sample with the reference metric to obtain a second indicator, and means responsive to each connection request for individually operating the selector in the first and second modes when the first indicator is greater and lesser, respectively, than the second indicator.

10. A terminal as defined in claim 9, further comprising means associated with the first and second comparing means and responsive to each connection request for adjusting the first and second indicators in accordance with selected criteria associated with the connection request.

11. In a radio transmission system having first and second channels separately configurable for the transmission of packets within a first frequency range in response to a connection request, the first and second channels supporting transmission in accordance with first and second transmission protocols:
means operable between first and second selectable modes for respectively routing the packets to be transmitted to a separate one of the first and second channels; and
means responsive to the connection request and coupled to the first and second channels for selecting the operating mode of the routing means in accordance with relative transmission condition(s) on such channels.

12. Apparatus as defined in claim 11, in which the first transmission protocol is the Blue tooth protocol.

13. Apparatus as defined in claim 12, in which the second transmission protocol is the 802.11 protocol.

14. A radio terminal for supporting packet transmission, which comprises:
a core;
at least one first interface associated with the core for supporting radio transmission within a first frequency range over an associated first channel in accordance with a first transmission protocol;
at least one second interface associated with the core for independently supporting radio transmission within the first frequency range over an associated second channel in accordance with a second transmission protocol;
means associated with the core for receiving connection requests for packets to be transmitted;
a selector coupled to the receiving means and operable between first and second modes for respectively routing the packets to a separate one of the first and second interfaces;
first means for collecting through the first interface, at first intervals, first samples representative of a selected transmission condition(s) on the first channel;
second means for collecting through the second interface, at second intervals, second samples representative of the selected transmission condition on the second channel;
first and second means individually coupled to the first and second interfaces for locally storing, over separately selectable times, the respective first and second samples;
first means for comparing the then-stored first samples with a reference metric to generate a refresh able first indicator;
second means for comparing the then-stored second samples with the reference metric to generate a refresh able second indicator; and
means responsive to the connection request for individually operating the selector in the first and second modes when the then-refreshed first indicator is greater and lesser, respectively, than the then-refreshed second indicator.

15. A terminal as defined in claim 14, in which the first transmission protocol is the Blue tooth protocol.

16. A terminal as defined in claim 15, in which the second transmission protocol is the 802.11 protocol.
